(19) United States
(12) Patent Application Publication
(10) Pub. No.: US 2023/0136369 A1
(43) Pub. Date: May 4, 2023

(54) WEARABLE MASK

(71) Applicant: Ki-tae BANG, Gangneung-si (KR)

(72) Inventor: Ki-tae BANG, Gangneung-si (KR)

(21) Appl. No.: 17/915,174

(22) PCT Filed: May 28, 2021
(86) PCT No.: PCT/KR2021/006672

§ 371 Date: Sep. 28, 2022

(30) Foreign Application Priority Data
Jul. 20, 2020 (KR) 10-2020-0089353

(51) Int. Cl. A62B 9/04; A41D 13/11

(52) U.S. Cl. CPC A62B 9/04; A41D 13/1161

(57) ABSTRACT

The wearable mask of the present invention has been developed such that a chin rest and string parts hung over the ears are made of silicone so that the movement of the face and the body is free, the mask is not shaken or separated, and there is no pain in the ears despite long-time use. The mask of the present invention is economical, has excellent marketability, and is advantageous for mass production.

### TECHNICAL FIELD

The present invention relates to a wearable mask.

### BACKGROUND ART

Sanitary masks are being used for various purposes, such as the blocking of fine dust and harmful gases, protection against cold, or the prevention of bacterial penetration.

The bodies of masks are made of functional fibers that consist of non-woven fabrics that act as a filter. A user wears a mask by pulling strings connected to a body and then hanging them over the ears.

The conventional masks are disadvantage in that it is not easy to manufacture them and also it is inconvenient to carry them because the strings of the masks have to be made long so that they can be hung over the ears, in that there are many cases where the stings of the masks put a burden on the ears and thus a user feels uncomfortable because the stings of the masks are worn on the ears, and in that when the conventional mask is worn together with glasses, strings are hung over the ears while overlapping the temples of the glasses, thereby making it cumbersome to wear the conventional mask together with glasses.

In order to alleviate these disadvantages, the present applicant has proposed an adapter made of silicone so that both ends of a mask support come into close contact with a user's cheeks and a wearable mask provided with the adapter in Korean Utility Model Application Publication No. 20-2019-0003039 and Korean Utility Model Registration No. 20-0490095. Products that embody the above patents have been put to use and have gained public favor.

The present invention is a further improvement over the above patents, and relates to a wearable mask that is improved such that a chin rest is introduced and also strings can be hung over the ears after the lengths thereof have been conveniently adjusted by taking into consideration the requests of actual consumers in the field where masks are worn.

Although various patents including Korean Patent Application Publication No. 10-2017-0119999 disclose the inventions in which the lengths of the strings of a mask are adjusted or connection portions between a mask body and strings are modified, they are problematic in that it is inconvenient to adjust the lengths of the strings and also frequent breakdowns occur due to the use of inflexible parts having complicated structures.

### DISCLOSURE

### Technical Problem

An object of the present invention is to provide a wearable mask that supports a wearer's chin, so that the wearing of the mask is stable even when the wearer's face or posture is changed.

An object of the present invention is to provide a wearable mask that allows the length of strings, hung over a wearer's ears from the mask, to be easily adjusted and can relieve the pain of the ears.

### Technical Solution

In order to accomplish the above objects, the present invention provides a wearable mask including a curved surface-shaped screen configured to cover the nose and mouth of a user, a thin curved plate-shaped frame configured to support the overall bottom portion of the screen, and connection portions formed at both ends of the frame, wherein a chin rest made of a soft material and configured to support a chin of the user is coupled to the central portion of the frame.

The chin rest may be intended to support a chin portion on the central portion of the lowermost part of the face of the user and include a first portion configured to support the upper portion of the chin exposed forward of the face and a second portion configured to cover the lower portion of the chin curved downward without being exposed forward of the face, and the first and second portions may be symmetrical with respect to a boundary line thereof and be formed to be slightly inclined from the front thereof to the rear thereof so that they come into close contact with and are tightened against the upper and lower portions of the chin of the user.

The chin rest may be made of silicone.

A flap long in leftward and rightward directions may be formed in a curved plate shape beneath the central portion of the frame, a slot may be formed inside the flap, a bridge may extend outward from a position near the boundary line between the first and second portions, and a coupling portion configured to be inserted into the slot may be formed on the front surface of the bridge.

String parts configured to be hung over the ears of the user may be fastened to the connection portions, each of the string parts may include a long string and a plurality of balls formed on the string, and each of the balls may be forcibly passed through an opening formed in a corresponding one of the connection portions, so that the length of the portion of the string hung over a corresponding one of the ears is adjusted.

The balls may be made of a silicone material, and may be movable along the string.

A cover wider than the string surrounding a corresponding temple of glasses of the user may be further formed on the side of the string opposite to the balls of the string.

### Advantageous Effects

The chin rest of the present invention can be manufactured and supplied as a separate unit according to the specifications of the mask, which exhibits the effects of being desirable for mass production and economically advantageous. The mask of the present invention provided with the chin rest enables the wearing of the mask to be more stable, and the mask does not move even when the face or posture is shaken or disturbed, so that it is convenient for daily work.

Furthermore, according to the mask of the present invention, the length of the parts hung over the ears can be easily adjusted, and also the pain applied to the ears can be relieved despite long-term use, so that the effect of improving marketability can be exhibited.

### DESCRIPTION OF DRAWINGS

FIG. 1 is a front perspective view illustrating a wearable mask according to an embodiment of the present invention;

FIG. 2 is a rear perspective view illustrating the wearable mask according to the embodiment of the present invention;

FIG. 3 is a front view of the wearable mask according to the embodiment of the present invention;

FIG. 4 is a side view of the wearable mask according to the embodiment of the present invention;

FIG. 5 is a perspective view of a string part;

FIG. 6 is a perspective view showing a state in which the string parts of FIG. 5 are fastened to connection portions;

FIG. 7 is a perspective view of a string part according to another embodiment of the present invention; and

FIG. 8 is a perspective view showing a state in which the string parts of FIG. 7 are fastened to connection portions.

### MODE FOR INVENTION

Preferred embodiments of the present invention will be described below with reference to the accompanying drawings.

However, the embodiments of the present invention may be modified to various other forms, and the scope of the present invention is not limited to the embodiments described below. In addition, the embodiments of the present invention are provided to more completely describe the present invention to those of ordinary skill in the art.

The meanings of the terms to be described in the present invention should be understood as follows.

A singular expression should be understood as including a plural expression unless the context clearly dictates otherwise. It should be appreciated that terms such as “comprise” or “have” are intended to specify the presence of described features, integers, steps, operations, components, parts, or combinations thereof, but do not preclude the possibility of the presence or addition of one or more features, integers, steps, operations, components, parts, or combinations thereof.

All the terms used herein have the same meanings as commonly understood by those of ordinary skill in the art, to which this invention pertains, unless otherwise defined. The terms defined in commonly used dictionaries should be interpreted as having meanings consistent with meanings in the context of the related art, and cannot be interpreted as having ideal or excessively formal meanings unless explicitly defined in the present invention.

The term “mask” used herein may include a mask for keeping warm, a sanitary mask, a mask for preventing fine dust, and the like.

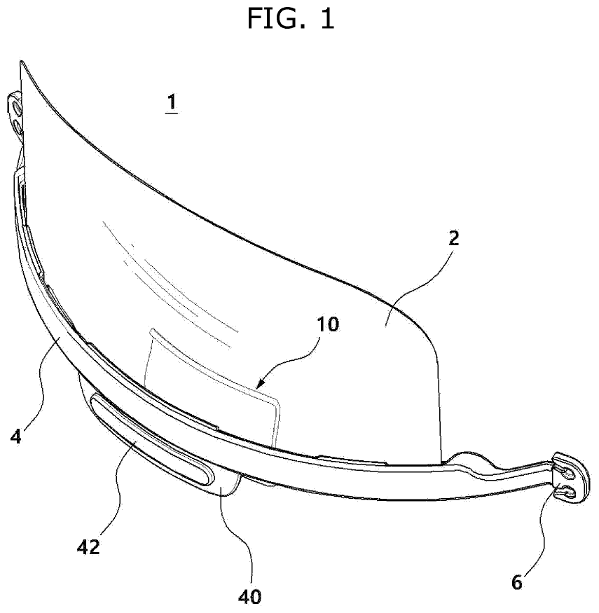

FIG. 1 is a front perspective view illustrating a wearable mask 1 according to an embodiment of the present invention. The basic shape and structure of the mask 1 are similar to those disclosed in Korean Utility Model Registration No. 20-0490095 issued to the present applicant.

The mask 1 includes a curved surface-shaped screen 2 configured to cover the nose and mouth of a user, a thin curved plate-shaped frame 4 configured to support the overall bottom portion of the screen 2, and connection portions 6 formed at both ends of the frame 4. The screen 2 is made of colored or uncolored synthetic resin. The frame 4 is made of synthetic resin or plastic that is harder than the material of the screen 2. A flap 40 long in the leftward and rightward directions is formed in a curved plate shape beneath the central portion of the frame 4, and a long slot 42 is formed in the flap 40 along the shape of the flap 40. The screen 2 and the frame 4 described above are examples, and the size, shape and material thereof do not limit the scope of the present invention.

The mask 1 according to an embodiment of the present invention is characterized in that it has a chin rest 10 and connection portions 6. The chin rest 10 is fitted in the slot 42, and string parts 20 configured to be hung over the ears of the user according to the present invention are fastened to the connection portions 6, as will be described later.

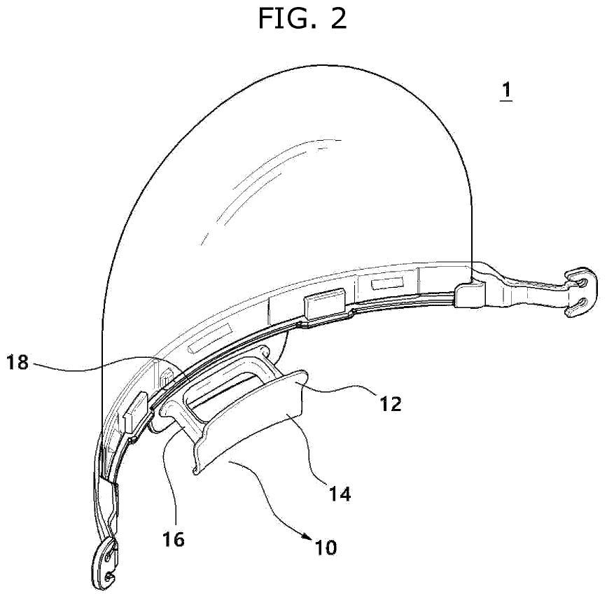

FIG. 2 is a rear perspective view illustrating the wearable mask 1 according to the embodiment of the present invention.

The chin rest 10 is intended to support a chin portion on the central portion of the lowermost part of a wearer's face. The chin rest 10 includes a first portion 12 configured to support the upper portion of the chin exposed forward of the face, and a second portion 14 configured to cover the lower portion of the chin curved downward without being exposed forward of the face. The first and second portions 12 and 14 are symmetrical with respect to the boundary line thereof. The first and second portions 12 and 14 are both formed to be slightly inclined from the front thereof to the rear thereof so that they come into close contact with the upper and lower portions of a user's chin as much as possible based on the boundary line and give a feeling of tightening. A pair of bridges 16 extend outward from both sides near the boundary line between the first portion 12 and the second portion 14. A coupling portion configured to be inserted into the slot 42 is formed on the front surfaces of the bridges 16. The shape of the coupling portion 18 is similar to that of the slot 42, and is fabricated in a size slightly larger than the slot 42 in order to be fixed after being forcibly pressed into the slot 42. Although the bridges 16 have been described as a pair, only one bridge 16 may be formed at the center.

It is preferable that the chin rest 10 of the present invention is fabricated in an integrated form by injection molding. In addition, it is preferable that the material of the chin rest 10 is silicone. In the case of silicone material, the elasticity and deformation thereof are free and the restoring force thereof is excellent. Accordingly, even when a wearer speaks while the chin rest 10 is provided, the chin and the muscles around it can move relatively freely, thereby minimizing discomfort. In addition, the operation of inserting the coupling portion 18 into the slot 42 also becomes considerably simple. The chin rest 10 can be manufactured and supplied as a separate unit according to the specifications of the mask, which is desirable for mass production and economically advantageous.

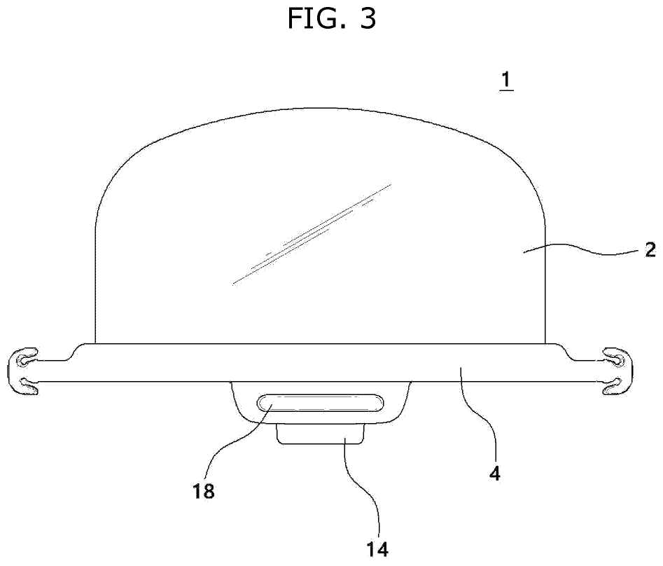

FIG. 3 is a front view of the wearable mask 1 according to the embodiment of the present invention.

When the front surface of the mask 1 is viewed from the center, the second portion 14 is exposed. The coupling portion 18 made of silicone is press-fitted into the slot 42.

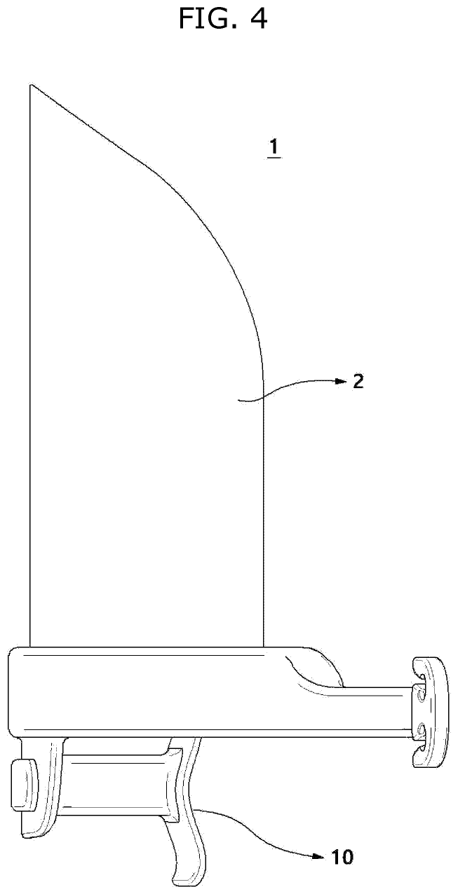

FIG. 4 is a side view of the wearable mask 1 according to the embodiment of the present invention.

According to the present invention, the wearing of the wearable mask is made more stable by the chin rest 10, and the mask 1 does not move even when the face or posture is shaken or disturbed, so that it is convenient for work.

Next, the string part 20 of the present invention will be described.

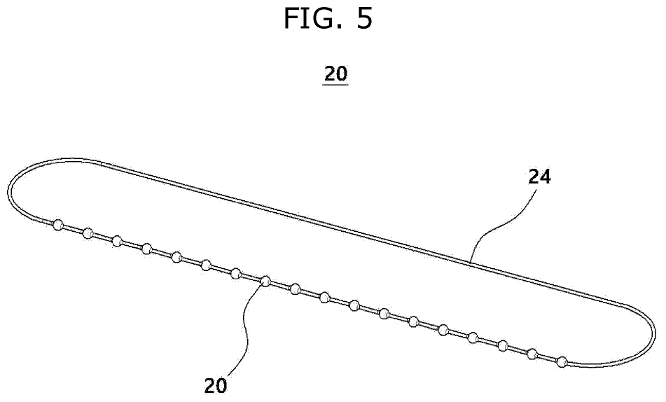

FIG. 5 is a perspective view of the string part 20. The string part 20 includes a long string 24 configured to form a closed curved surface with rounded corners, and a plurality of balls 22 formed on the string 24. The balls 22 may be moved by pushing or pulling them along the string 24 with a finger. The balls 22 are made of a silicone material.

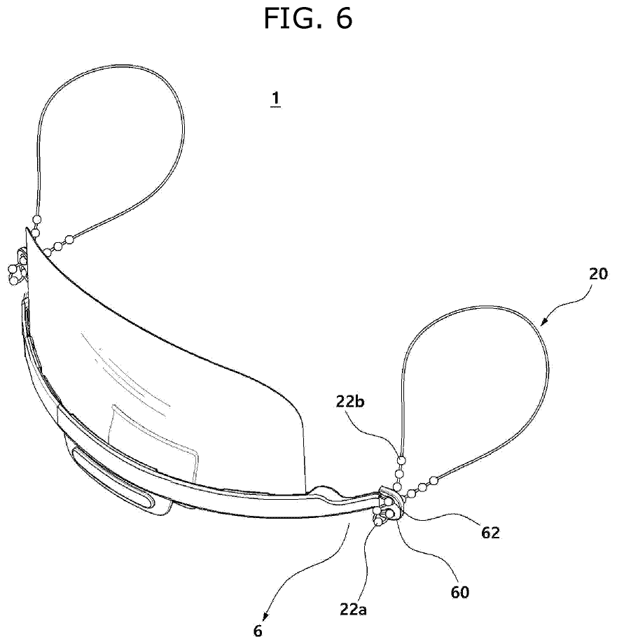

FIG. 6 is a perspective view showing a state in which the string parts 20 of FIG. 5 are fastened to the connection portions 6.

The connection portions 6 include bases 60 formed in an integrated manner at both ends of the frame 4. Openings 62 having a diameter smaller than that of the balls 22 are formed in the upper and lower portions of the side surface of each of the bases 60. Each of the openings 62 is an open type with one side open as shown in the drawing, so that the string part 20 can be easily and selectively fitted and separated by inserting or removing the thin string 24 into or from the opening 62. In this regard, the string part 20 can be separately manufactured and supplied as a separate unit according to the specifications of the mask, which is desirable for mass production and economically advantageous.

In order to reduce the length of the string part 20 of the mask 1 hung over the ear, the ball 22b inside the mask 1 is elastically deformed and forcibly passed through the opening 62 outward by pulling the ball 22a outside the mask 1 or the portion of the string 24 where the outer ball 22a is located. In contrast, in order to increase the length of the string part 20 of the mask 1 hung over the ear, the ball 22b outside the mask 1 is elastically deformed and forcibly passed through the opening 62 inward by pulling the ball 22a inside the mask 1 or the portion of the string 24 where the inner ball 22a is located.

The reason why that it is convenient to adjust the distance between the string part 20 and the ear is that the balls 22 (22a, and 22b) are made of a silicone material, and also there is no risk of being damaged or broken despite long-term use.

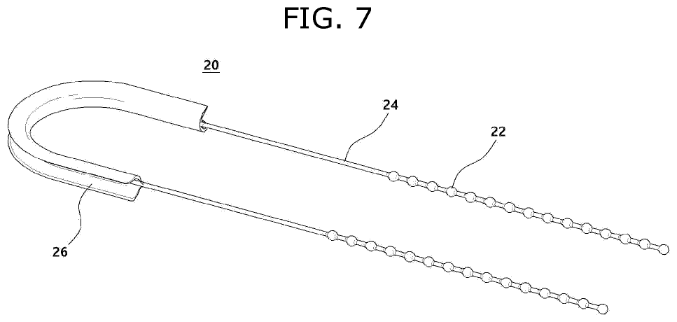

FIG. 7 is a perspective view of a string part 20 according to another embodiment of the present invention. The present embodiment is different from the previous embodiment in that a cover 26 made of rubber or silicone is further formed on the side of a string 24 opposite to balls 22 along the length of the string 24. The cover 26 is a part that comes into direct contact with the ear. Since the cover 26 is wider than the string 24, the area in contact with the skin is wide, so that the pressure normally applied by the string can be relieved. Also, the pain applied to the ear can be reduced using the characteristic of a soft material.

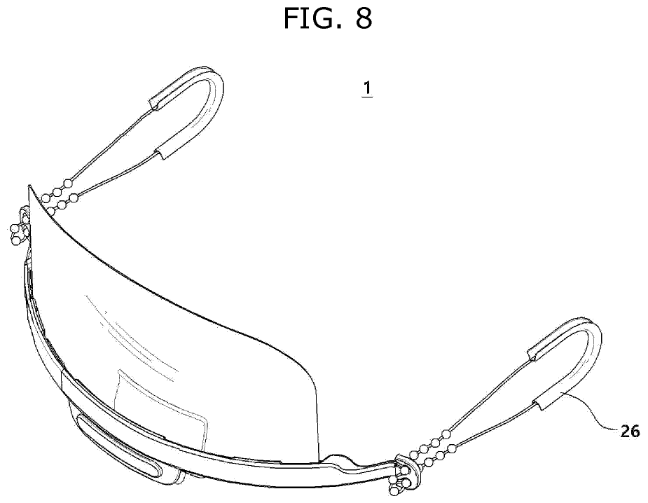

FIG. 8 is a perspective view showing a state in which the string parts 20 of FIG. 7 are fastened to connection portions 6.

As in the above-described embodiment, the lengths of the portions hung over the ears can be easily adjusted, and also the pain applied to the ears can be relieved despite long-term use, so that there is an advantage of excellent marketability.

In particular, the pain caused by the temples of glasses can be removed by softening the portions of the temples of the glasses caught on the ears when a user wears the glasses.

Although the specific embodiments according to the present invention have been described so far, various modifications may be made without departing from the scope of the present invention. Therefore, the scope of the present invention should not be limited to the described embodiments, but should be defined by not only the attached claims but also equivalents to the claims.

1. A wearable mask comprising a curved surface-shaped screen configured to cover a nose and mouth of a user, a thin curved plate-shaped frame configured to support an overall bottom portion of the screen, and connection portions formed at both ends of the frame, wherein a chin rest made of a soft material and configured to support a chin of the user is coupled to a central portion of the frame,
wherein the chin rest is intended to support a chin portion on a central portion of a lowermost part of a face of the user, and comprises a first portion configured to support an upper portion of the chin exposed forward of the face, and a second portion configured to cover a lower portion of the chin curved downward without being exposed forward of the face, and the first and second portions are symmetrical with respect to a boundary line thereof, and are formed to be slightly inclined from a front thereof to a rear thereof so that they come into close contact with and are tightened against the upper and lower portions of the chin of the user.

2. The wearable mask of claim 1, wherein the chin rest is made of silicone.

3. The wearable mask of claim 2, wherein a flap long in leftward and rightward directions is formed in a curved plate shape beneath a central portion of the frame, a slot is formed inside the flap, a bridge extends outward from a position near the boundary line between the first and second portions, and a coupling portion configured to be inserted into the slot is formed on a front surface of the bridge.

4. The wearable mask of claim 1, wherein string parts configured to be hung over ears of the user are fastened to the connection portions, each of the string parts comprises a long string and a plurality of balls formed on the string, and each of the balls is forcibly passed through an opening formed in a corresponding one of the connection portions, so that a length of a portion of the string hung over a corresponding one of the ears is adjusted.

5. The wearable mask of claim 4, wherein the balls are made of a silicone material, and are movable along the string.

6. The wearable mask of claim 4, wherein a cover wider than the string surrounding a corresponding temple of glasses of the user is further formed on a side of the string opposite to the balls of the string.
